(19) United States
(12) Patent Application Publication
(10) Pub. No.: US 2005/0193017 A1
(43) Pub. Date: Sep. 1, 2005

(54) Portable multimedia player/recorder that accesses data contents from and writes to networked device

(76) Inventor: Han-Gyoo Kim, Irvine, CA (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 11/062,104

(22) Filed: Feb. 18, 2005

Related U.S. Application Data
(60) Provisional application No. 60/546,090, filed on Feb. 19, 2004.

(51) Int. Cl. G06F 17/00

(52) U.S. Cl. 707/104.1

(57) ABSTRACT

Media content player that access content to be played from networked media content data storage source without storing on player. System and method for accessing and playing media content. Portable wireless multimedia player. Media player including control device for receiving user input, content access and performance module, wherein content access and performance module includes directory content search element, content player element, optional content decoder element, and optional network controller element. Method for accessing content for player where content is accessed from networked storage system or device, processed for playback on the device, and played without storing any appreciable amount of the content on the player, so that no content was stored before request or after completing playback. System for providing library of media and multimedia content to thin low-cost media player device, the system including media player, network, and networked storage device coupled to player over the network

### RELATED APPLICATIONS

This patent application claims the benefit of priority under 35 U.S.C. §119 and/or 35 U.S.C. §120 to U.S. Provisional Patent Application Ser. No. 60/546,090 filed 19 Feb. 2004 entitled Portable Multimedia Player/Recorder That Accesses Data Contents From And Writes To Networked Device, and which is hereby incorporated by reference.

U.S. patent application Ser. No. 09/974,082, entitled “Disk System Adapted to Be Directly Attached to Network” filed Oct. 9, 2001; U.S. Provisional Patent Application Ser. No. 60/603,917, entitled “A Network Direct Attached Storage Suitable for Home Network,” filed Aug. 23, 2004; U.S. Nonprovisional patent application Ser. No. 10/195,817, entitled “Scheme for Dynamically Connecting I/O Devices Through Network” and filed on Jul. 15, 2002; and U.S. Provisional Application Ser. No. 60/590,722, entitled “Low Level Communication Layers and Device Employing Same” and filed on Jul. 22, 2004; all of which are related applications that are hereby incorporated by reference as if fully set forth herein.

### FIELD OF THE INVENTION

This invention relates generally to a media or content player with optional recorder that access media content to be played or performed from a networked media content data source, and more particularly to a portable multimedia player with optional recorder that accesses the media content or other data over a network from a networked data storage device, and even more particularly to a portable multimedia player with optional recorder that accesses the media content or other data over a network from network attached disk or other storage.

### BACKGROUND OF THE INVENTION

Heretofore, there have been many media content players including many portable multimedia content players, but these have all accessed the data contents from a storage device that is an integral component of the player itself, such as a hard disk drive, internal solid state memory such as a flash memory, or through a device such as a CD or DVD player that accesses the contents from a storage medium such as a CD or DVD. The media or multimedia contents may for example be a form of audio (such as music, spoken books, educational materials, or the like), video (such as images, photographs, movies, television), of some other combination of media or multimedia types. In any of these conventional player devices and methods, the multimedia contents data have to reside within the portable player in much the same way as with a non-portable player. These current portable multimedia players include, for example, portable CD and DVD players, MP3 music players such as the Apple iPOD®, personal data assistants (PDA's) that have a media playback feature, computers that can playback multimedia, and other audio, video, audio-video or other multimedia playback devices. In configurations where the multimedia content data reside locally within the player device, the very features that permit the player to be a portable device, also inherently impose certain limitations on its structure, operability, and usability.

When the media or multimedia content data and the player are located in a single device, the amount or size of content that are “portable” have to be limited by the storage device or medium that is employed by the player. The storage may be a CD, a DVD, a hard disk drive (HDD), a compact flash card, a flash memory, or any of the other types of magnetic, optical, or solid state memory available for data, file, or content storage. Significantly, the multimedia content data, whether stored in a storage device component of the player such as a HDD, or in a storage medium inserted into a reader device within the player such as a CD or DVD (and CD or DVD reader), the contents can only be reproduced onto the same player that holds the data storage. That is, each and every content are reproduced “exclusively” to the player with the data and reproduction of the same contents to multiple numbers of distinct viewers is impossible. Hence, all current portable multimedia players can be called “personal” in the sense that the contents can only serve its one owner. (This ignores the trivial situation where a player device may be fitted with multiple ear-bud or headphone cables so that two persons sitting next to each other can listen to and/or watch the identical content at the identical time.) Such service limitations by and large result because the multimedia content data are “exclusive” to the player and can only be accessed by a single player that either mounts the media item storing the multimedia content or stores a file or other data (such as a compressed digital audio music file) in an internal storage.

Existing players also do not usually include a recording capability, and even if such recording capability were to be provided, the ability to record may generally be restricted based on the available unused memory within the player. Frequently, users of conventional players will load many media content items onto their player and retain them there for later playback. If a need arises (perhaps suddenly) to record an event such as by taking a picture, recording some video, or making an audio recording, such recording may not be possible because there is insufficient available memory in the player. The user may be forced to either delete media content that may not otherwise be backed-up, or if the person is traveling where the deletion would represent a great inconvenience.

In light of these limitations, it will be appreciated that there is a need for a media or multimedia player that overcomes this service limitations by making the multimedia content data “non-exclusive” to the player so that it may be made accessible in some form to a multiplicity of players and so that multimedia content data may be shared by multiple numbers of players and the amount of media content data that are accessible to each multimedia player need not be limited by the storage device component or the medium used by the player.

There is also a need for a multimedia player that is not limited to the storage capacity of an internal storage device (such as a hard disk drive or flash or other solid state or electronic memory) or by the capacity of a media content storage (such a CD or DVD) carried by the player so that a user can play any one of an essentially unlimited number of multimedia content titles.

There is also a need for a multimedia player where neither the physical size nor the portability of the player have any bearing on the amount of media content data that the player has access to.

There is also a need for a multimedia player that includes a recording capability and where the amount or size of the recording is not limited by the storage within the recorder device itself.

There is yet another need for a media or multimedia player where the monetary cost of the player may be kept low by eliminating any mass storage memory device such as a hard disk drive or solid state memory, without limiting the amount of media content data that the player has access to.

### SUMMARY

A media or content player with optional recorder that access media content to be played or performed from a networked media content data storage source. System and method for accessing and playing media content. A portable media or multimedia player with optional recorder that accesses the media content or other data over a network from a networked data storage device. A portable wireless multimedia player with optional recorder that accesses the media content or other data over a network from network attached disk or other storage.

A media player including a control device for receiving a user input, a content access and performance module, wherein the content access and performance module includes a directory content search element, a content player element, an optional content decoder element, and a optional network controller element.

A method for accessing media or multimedia content from a thin media player where the media or multimedia content to be played is accessed from a networked storage system or device, processed in real-time or near-real time for playback or reproduction on the device, and played or reproduced on the device without storing any appreciable amount of the content on the player.

A system for providing a library of media and multimedia content to a thin low-cost media player device, the system including a media player, a network, and a networked storage device couplable to the player over the network.

### BRIEF DESCRIPTION OF THE DRAWINGS

FIG. 1 is a diagram of the portable multimedia player of the present invention connected to a networked storage via a network.

FIG. 2 is a schematic diagram of the hardware/software module of the present invention.

FIG. 3A is a diagram of the player of this invention and a networked or networkable storage attachment, where a direct connected is established.

FIG. 3B is a diagram showing multiple numbers of players of this invention connected to a networked storage device via a network hub.

FIG. 4A a schematic diagram of an exemplary embodiment of a hardware/software module where an encoder has been added.

FIG. 4B is a diagram showing the player of this invention connected to a networked storage via a network and where audio/video connection is establish with multiple numbers of television TV sets.

### DETAILED DESCRIPTION OF EXEMPLARY EMBODIMENTS

The present invention allows a media or multimedia player, recorder, or player and recorder to access contents stored in a storage device that is remote from player such as from a wired or wireless network in order to provide true portability of the player/recorder and virtually unlimited media content access capacity in a small, lightweight, and inexpensive device. In one embodiment, the invention allows a multimedia player/recorder to access contents stored in a storage device that is attached directly to a network, such as for example, the Internet, an intranet, a local-area network (LAN), a wide-area network (WAN), an Ethernet network, or any wired or wireless network, or any other network now known or to be developed. Furthermore, the network and direct connections between the portable multimedia player and the networked storage devices or subsystems can be any one of, but not limited to, the following: an Ethernet connection, a USB connection, or an IEEE 1394 connection.

In accordance with one aspect of the invention, the problems and limitation of conventional media player devices and playback methods are achieved by providing network interface to the player alone, recorder alone, or a combined player/recorder of the present invention through which the player/recorder accesses where multimedia contents are stored and shared by multiple numbers of player/recorder of the present invention. (To avoid overly verbose description, as used in this description without further qualification, the term player or player device will be understood to include an optional recorder or recorder component or capability within the player.) The service limitations present in conventional players are surmounted in the invention by making the multimedia content data “non-exclusive” to the player and storing or otherwise making them accessible from a remote location, so that the media content data can be accessed by multiple numbers of players over an available communications link, such as over a network. In this way, multimedia content data may be shared by distinct multiple numbers of players and the amount of data that are accessible to each multimedia player need not be limited by the storage device component or the medium used by the player.

In one embodiment of the invention, a portable multimedia player obviates the necessity of retaining a data storage device or a storage medium by accessing the multimedia contents data from a storage device over a network. The network and networked storage device may any of the types known in the art, however, certain particular types are particularly advantageous.

One such storage device is a network attached disk (NAD) while another is a NetDisk®-type network directly attached storage device (made by XiMeta Inc. of Irvine, Calif.). These NAD and NetDisk®-type networked storage devices that are directly attached to the network and can be accessible to the computer over the network as source of media content for playing on the inventive player device, or for recording content received or generated by an optional recorder component of the player/recorder device. When coupled with or connected to the player of this invention over the network, the NAD and NetDisk® networked storage devices allow the player to recognize that storage as the player's own storage and mimic internal hard disk drive, solid state memory, optical memory, or other internal storage. Hence the invention provides the first multimedia player without the media content data residing within the device, but accessed from a remotely located storage device connected over a network. Of course the storage device may in fact be physically close (not physically remote) but have access provided remotely over the network. It is noted that NetDisk® is a registered trademark of XiMeta, Inc., 15251 Alton Parkway, Irvine, Calif. 92618.

Although the invention is not limited to network-attached disk (NAD) and/or NetDisk®-type network storage devices, attributes of selected embodiments of NAD, NetDisk®-type directly attached passive network storage devices are described in co-pending patent application Ser. No. 09/974,082 filed 9 Oct. 2001 entitled Disk System Adapted To Be Directly Attached To Network, and herein incorporated by reference in its entirety. Although such network-attached disk (NAD) or NetDisk®-type directly attached network storage devices such as hard disk drives are well adapted to be used with and to cooperate with features of the instant invention, the instant invention is not limited to operate only with such NAD or NetDisk®-type directly attached network storage devices.

As described in U.S. patent application Ser. No. 09/974,082, an embodiment of network-attached disk (NAD) system includes an NAD device for receiving a disk or other storage device access command (or data) from a device (such as the inventive player or other information appliance or computer) over a network, and a device driver in or at the player for controlling the NAD device through the network, where the device driver may create a virtual host or player bus adapter so that the player recognizes the NAD device as if it is a local device to the player. The NAD device itself may include a disk or other storage means for storing data, a disk or other storage media controller for controlling the disk or other storage media, and a network adapter for receiving a disk or other storage device access commands from the player or player/recorder through a network port.

Several advantages are offered by the portable multimedia player of the present invention over conventional players. First, with the multimedia content data residing remotely, apart from the player, it becomes feasible for multiple numbers of listeners and/or viewers who are connected to the same network storage (such as, but not limited for example to NAD or NetDisk® type storage) from different locations to access the same multimedia contents independently, since each player of this invention may be configured to recognize the remote external storage as its own internal storage. In one embodiment of a player, a network-attached NetDisk® type storage device is seen within the player as its own hard disk drive (HDD). The implication of this advantage may be enormous. In a situation where more than one person wants to access the same contents independently from others who may be accessing the same contents, one possible means of allowing this independent sharing of same contents is to provide the media content data in storage that is separate and apart from the player and allow multiple accesses from multiple players as is the case with the present invention.

Another advantage is that since the multimedia content data are stored on a remotely located storage device, the portability of the player does not have any bearing on the amount of data that the player has access to. The amount of multimedia content data that the portable multimedia player of this invention may access and play may only be limited by the storage size of the remotely located storage device or subsystem to which the player is connected. And when the player is connected to multiple numbers of network storage devices over the network, the amount of multimedia contents can be practically limitless.

Furthermore, since the player does not need to store any of the media content data, except optionally temporality buffer a small amount so that smooth playback may be maintained while accessing the networked storage device, the player does not need very much memory. In fact, in one embodiment memory present with a low end micro-controller, digital signal processing circuits, of other logic circuits may be sufficient. The player is not precluded from having additional memory, and embodiments of the invention may provide for optional random access memory if desired. Embodiments of the invention may also be included within other devices that have greater processing power and memory, such as PDAs, cell telephones, digital cameras, or the like.

Various particular embodiments of the invention are now described.

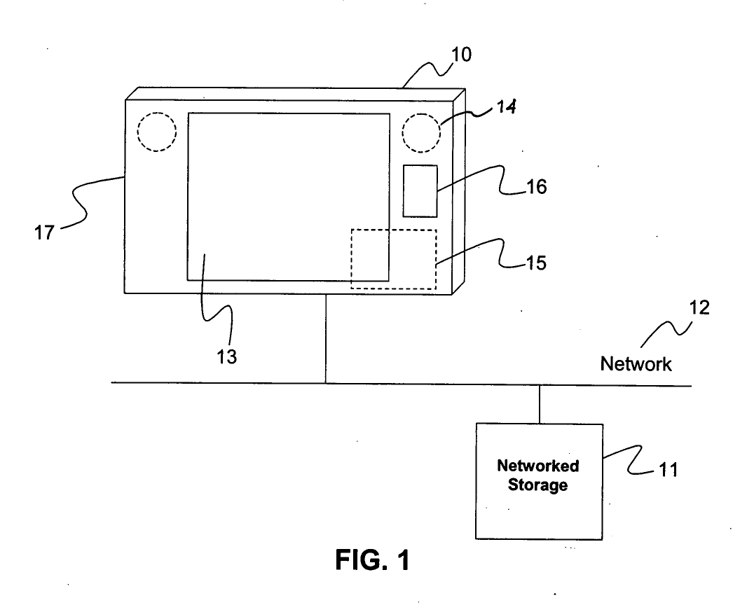

FIG. 1 is a diagram of an embodiment of the portable multimedia player 10 of the present invention which accesses the contents data from a remote networked storage 11 over a network 12, such as for example from a remote network accessible hard disk drive or other networked storage device or storage subsystem. The network storage may be a network-attached disk (NAD) or a NetDisk®-type network attached hard disk drive or other network attached storage device. Attributes of selected embodiments of directly attached network storage devices such as but not limited to network-attached disk (NAD) or NetDisk®-type storage devices as are described in co-pending patent application Ser. No. 09/974,082 filed 9 Oct. 2001 entitled Disk System Adapted To Be Directly Attached To Network, and herein incorporated by reference in its entirety.

The multimedia content data (or more simply media, contents, data, or media contents) which the player of this invention may play, reproduce, or performs on one or the display monitor 13 and/or audio transducers such a speakers or earphones 14 do not reside in the player but are accessed from the networked storage 12, such as a storage device directly attached to the network which in some embodiments may advantageously be recognized as the player's own storage device and in other embodiments as an external but accessible storage device. The multimedia contents data files are accessed from the networked storage 11 through a hardware/software module 15 using a control device for user input 16 and headphone jack 17 may also be provided for personal listening is speakers 14 are not provided or not desired. Embodiments of the invention may provide for speakers, earphones, video display, and/or certain controls to be absent and provided by external devices that are plugged into or otherwise coupled with the player 10.

It will be appreciated in light of the description provided here, that one of the differences between the player of this invention and the conventional portable multimedia players or jukeboxes is that the present invention does not store of contain the entire multimedia content data files for the media content item being played within the player device, but rather accesses the media content data over the network from a remotely located networked storage 11. This separation of the player and the multimedia contents data enables multiple numbers of players to access all the contents from a single storage device independently.

More particularly embodiments of the invention may provide for no storage of the media content item being played so that the media content item is processed for reproduction on the player (such as by decoding, decompressing, or the like) and reproduced in real-time or substantially real-time as it is received from the network. This may not be preferred since a continuous uninterrupted media content data stream or download may not be guaranteed under all network and networked storage access conditions. Therefore, other embodiments of the invention may provide for some buffer storage so that a selected portion of the media content data selected for playback may be pre-fetched or otherwise accessed in advance of playback. For example, 10, 20, 30 seconds worth or an identified file size portion may be identified to be accessed by the player and buffered until it is time to play that portion. Subsequent retrieval of additional portions of the media content may be fetched in advance of those portions being reproduced and the reproduction of one portion may occur simultaneously with the fetching or downloading of another portion. Other embodiments of the invention may fetch or download from the networked storage entire media content items, or even a plurality of entire media content items, however, in these embodiments not all of the benefits of a player having minimum internal storage may be realized. Storage of all or portions of media content items may be a design or user selectable option. Embodiment of players incorporating the invention may also or alternatively provide a capability to also insert a local media storage, such as a flash memory device, into the player and play stored as well as networked storage accessed media contents.

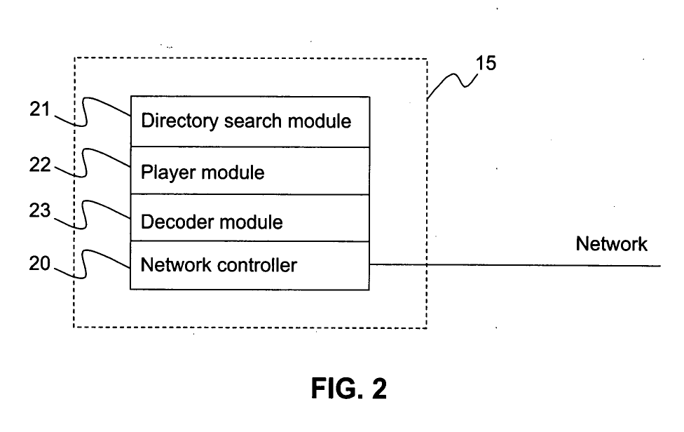

FIG. 2 is a schematic diagram of an embodiment of the a hardware/software module 15 inside the portable multimedia player 10 of this invention. The connection between the player of this invention and a networked storage 11 over a network 12 is established with a network controller 20. When the network connection is established with an NAD or NetDisk®-type networked storage 11, the NAD or NetDisk® type networked storage 11 may optionally be recognized as the player's own hard disk drive or other type of the player's own storage. When other types of networked storage are accessed, the networked storage 11 may appear as either the player's internal storage or as an external storage depending for example on the particular characteristics of the networked storage, and configuration information or software/firmware within the player 10.

The directory search module 21 enables the player of this invention to access the multimedia contents data files from the connected networked storage 11 for reproduction by the player module 22. The player module 22 is responsible for playing the media content that may generally have been received after the decoder module 23 has performed some decoding operation on the raw media content received from the networked storage over the network. The player module 22 may generally be configured to support a variety of multimedia audio and video formats. Typically, the player module may comprise portions of the hardware/software module 15. The player module receives the data for display decoded by the decoder module 23 that decodes the multimedia contents in various formats from the networked storage 11.

By way of example, but not limitation, the media content data may be compressed by a hardware or software data compressor prior to being received, or where a recorder function is provided, the encoder may encode data to anyone of several known or to be developed future formats. For example, audio media content (such as from CDs or DVDs) may be converted to smaller, compressed Moving Picture Experts Group-1—Audio Layer 3 (MP3) or Audio Layer 4 (MP4) audio files by an appropriate encoder or converter, thus allowing faster download buffer storage (if any) requirements. Similarly, video segments on DVDs may be converted to a lower video resolution (such as MPEG-2 or Apple's QUICKTIME format) by a video resolution converter or other encoder/decoder, thus requiring less storage space and faster upload/download times.

Embodiments of the invention may provide that the hardware/software module 15 may comprise analog and/or digital circuits, and may usually also include some digital processing logic for providing the network controller, media content decoding, and playback. Components of the same hardware/software module 15 may also provide al or a portion of the directory search module functionality and control and/or interface with the user input 16. Controller, micro-controllers, processors, microprocessors, logic circuits, and other standard and/or custom circuits and devices for processing data may be employed to implement the hardware/software module 15. Advantageously, the module 15 will be programmable and include an ability to be updated or otherwise modified, such as for example to provide for new media types, or the like; however, some embodiments may provide simpler fixed or hardwired circuitry for a predetermined set of operations.

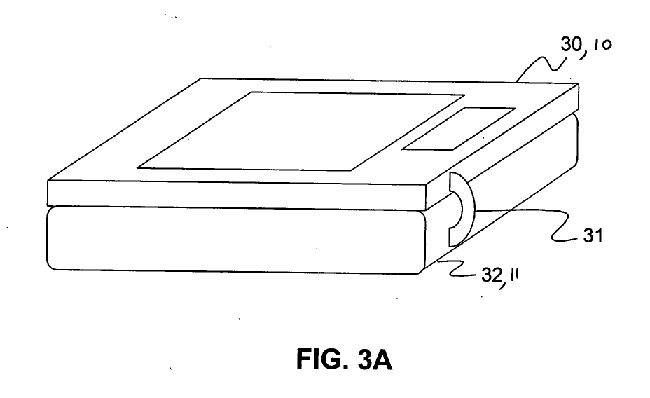

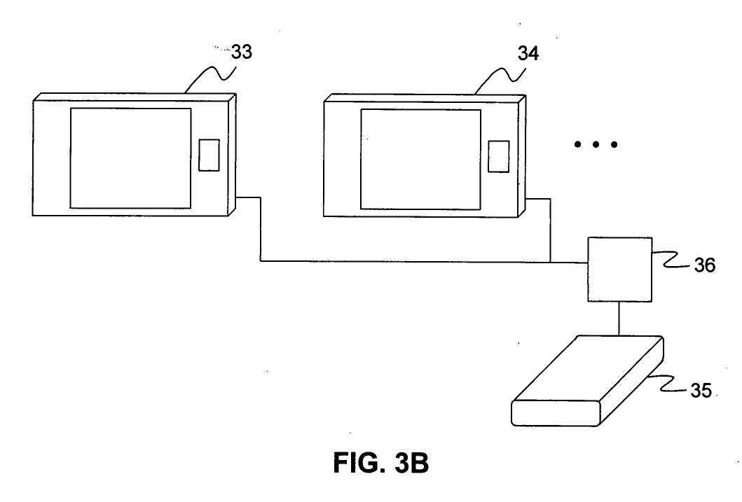

With reference to FIG. 3A, there is depicted a physical perspective view of an embodiment of the invention. In this embodiment, the media player 10, 30 is illustrated as having a connection to the storage device when a connection 31 is established with a the networked storage 32, 11 away from a network 12. The storage 32 may for example be a NAD or NetDisk® 32 that is directly connected rather than being connected over a network 12. Matching or mating electrical and/or mechanical connections may be provided on the player 10, 30 and on the storage device 32 to facilitate the attachment, or wires, cables, or optical or other wireless connectivity may be employed.

Moreover, when multiple numbers of players 33, 34 of this invention are connected to the same networked storage 35 (such as for example to a NAD or NetDisk®-type directly network attached storage) via a network hub 36, as depicted in the embodiment of FIG. 3B, each player may be configured recognize the same networked storage 35 as its own storage device. This is equivalent to having multiple numbers of independent portable multimedia players with same number of media content data storages enabling each user to access the same and/or different multimedia contents data files synchronously and/or asynchronously from a single networked storage. This is a unique feature resulting from a combination of multiple numbers of players of this invention and networked storage, which is currently unavailable through any combination of currently available conventional multimedia players and storage devices. Again this is only possible when the media content are stored not within the player but reside in a storage device attached directly to the network. Advantageously, the players 33, 34 are networked to NAD or NetDisk®-type networked storage 35 via hub 36.

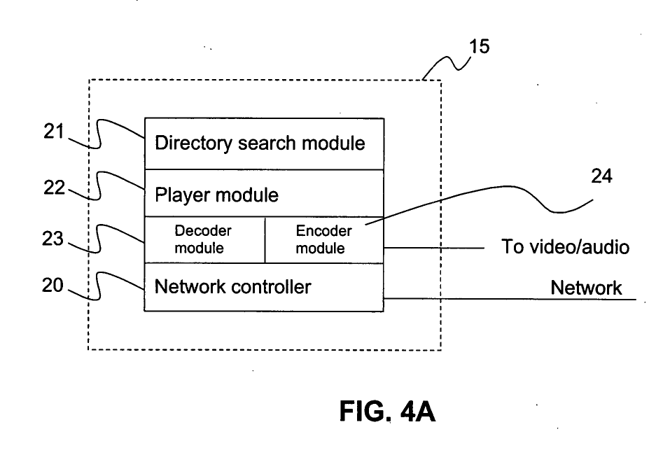

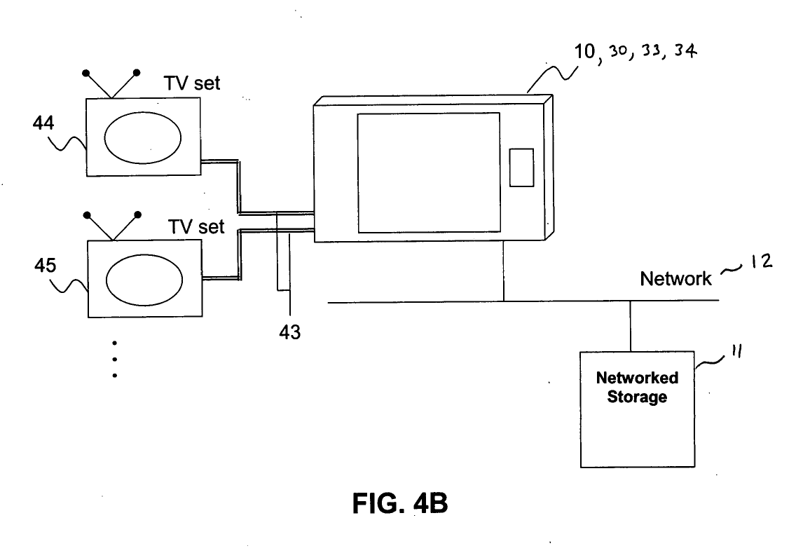

With reference to FIG. 4A, the hardware/software module 15 of the multimedia player 10, 30, 33, 34 of this invention may be provided with an encoder 24 for television (TV) signals (or other data encoding function) in addition to the decoder 23 for the multimedia contents in the storage device. An audio/video connection 43 between TV sets 44, 45, the player 10 and the networked storage 11 may also be established as illustrated in the embodiment of FIG. 4B, so that it becomes possible to reproduce the multimedia contents on a TV set and also to record TV programs (or other multimedia content) back onto the networked storage 1 over the network 12. Again, with the multimedia contents data located remotely from the player, it becomes possible to reproduce different and/or same contents independently to multiple numbers of TV sets and also to make recordings of different TV programs from multiple numbers of TV sets to the same networked storage at the same time. When the networked storage is a large storage device, or where a plurality of networked storage devices are made available, the storage capacity for recording from or through the player/recorder 10 is virtually unlimited, and certainly larger than conventional portable player/recorders. Of course the content may later be access and retrieved as for any other media content data.

Certain configurations of players, players with recorders, and connections between players with networked and non-networked storage devices have been described; however, it will be appreciated that these are merely exemplary embodiments and do not limit the invention.

For example, the connection to the networked storage 11 over the network 12 may be done through a wireless connection and this will render the player of this invention a truly portable player, a sometimes referred to as a “player-only” player without contents data residing on or stored within the player. Also, with a decoder to decode the audio/video signals from the player, the multimedia contents may be reproduced on a TV set and/or a stereo system. Another configuration of the inventive player may be where the player of this invention and a networkable storage that is not then currently networked are directly attached, or attached or connected through an adapter, to each other to form a single device similar to the current portable multimedia players. In this configuration, the player is still configured without its own storage or with only a limited amount of storage for buffering the media contents. Note that with a direct or other guaranteed high-speed connection that can keep up with the player playback or reproduction data rate, there may not even be any need for buffering of the media content as it is received from the storage device.

The difference would be that the media contents data would still reside outside of the player itself and in the networkable storage device (even if locally or directly connected), which is recognized as the player's own storage device but could be detached and replaced with another storage device as if it were an external storage device. Hence, when multiple numbers of the players of current invention are attached to the same networked storage directly via a network hub, it becomes possible for a single networked storage to provide independent services to each one of the attached players with any and all of the media contents. Furthermore, when the networked storage 11 is a NAD-type, or NetDisk®-type networked storage, or where other identification software and/or hardware means are provide, some or each of the players 10 of this invention may recognize the attached networked storage as its own storage device. This feature will provide a hitherto unavailable function from the current portable multimedia players and can be a most welcome feature when applied to automobile multimedia players.

Embodiments of the invention may further but optionally include a user output device (not shown), such as a monitor, liquid crystal diode (LCD) display, or other means for relaying the current operation, status, and other pertinent information to a user regarding the player 10, including information about media content items available from networked storage 11, such as may be determined and maintained by the directory search module. The directory may be maintained in the player, generated dynamically when the player tries to connect to the network, or maintained on a networked storage device for download to the player when the player makes an inquiry or otherwise connects with or attempts to communicate with the network. The display device may be more elaborate and be able to display color photographs, moving images or video, or otherwise directly reproduce or play such multimedia content.

The foregoing descriptions of specific embodiments and best mode of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A media player comprising:
a control device for receiving a user input;
a content access and performance module;
the content access and performance module comprising: a directory content search module (DCSM), a content player module (CPM), a content decoder module CDM, and a network controller module NCM.

2. A media player as in claim 1, further comprising a housing and a display exposed at or through a surface of the housing.

3. A media player as in claim 2, wherein the display identifies media content that is accessible over the network and that may be played on the media player.

4. A media player as in claim 3, wherein the media content accessible over the network includes content identified by the directory content search module.

5. A media player as in claim 1, wherein the display selectably presents a menu for interaction with the control device.

6. A media player as in claim 1, wherein the content access and performance module further comprises a media content encoder module and an optional recorder module coupled with the encoder module to receive an encoded media content and to direct recording of the encoded content onto a networked storage device.

7. A media player as in claim 1, further comprising a audio signal generator coupled to the decoder module and receiving the decoded signal and generating an audio reproducible signal for playback to a user of the media player.

8. A media player as in claim 1, wherein the control device for receiving a user input further comprises a user input interface device selected from the set of input devices consisting of a touch-screen input device, a thumb-wheel input device, a joy-stick input device, a four-way toggle button, a plurality of buttons for scrolling and selection, a voice-actuated input device, and any combination of these input devices.

9. A media player as in claim 1, wherein the control device further comprises means for directing the content access and performance module to access and play a particular media content selected by the user input to the control device.

10. A media player as in claim 1, wherein the directory content search module further comprises first logic that enables the media player to access networks and devices accessible over the networks storing media content through the network control module, and identify media sources and storage coupled to the network that store or source media content than can be accessed and played by the media player.

11. A media player as in claim 1, wherein the directory content search module (DCSM) directs a passive query or an active query of the network to identify media content that may be accessed by the media player and generates a list of media content that may be accessed.

12. A media player as in claim 11, wherein the active query sends messages over the network to interrogate the network and identity sources including storage devices where playable media content is available.

13. A media player as in claim 11, wherein the passive query listens for messages broadcast over the network identity sources including storage devices where playable media content is available.

14. A media player as in claim 1, wherein the directory content search module (DCSM) further identifies accessible media content that may be played on the media player alone, and media content that may be accessed through the media player but may use additional playback means coupled with the media player to play additional content not playable solely by the media player.

15. A media player as in claim 1, wherein the content access and performance module further comprises a digital logic circuit.

16. A media player as in claim 15, wherein the digital logic circuit comprises a processor having a predetermined amount of random access memory.

17. A media player as in claim 16, wherein the predetermined amount of random access memory is a memory size that is less memory than an amount of memory required to store a complete media content from a starting portion to an ending portion item.

18. A media player as in claim 16, wherein the predetermined amount of random access memory is the only random access memory in the media player.

19. A media player as in claim 1, wherein a total size of memory available for content accessed over the network is less than the media content size of at least one media content item that can be played on the media device.

20. A media player as in claim 19, wherein the total size of memory available for content accessed over the network is substantially between 1 kilobytes and 1000 kilobytes.

21. A media player as in claim 19, wherein the total size of memory available for content accessed over the network is less than 1 Megabyte.

22. A media player as in claim 1, wherein the media player does not store an entire media content item within the media player before, during, or after accessing or playing of the media content item.

23. A media player as in claim 1, wherein the media player does not store an entire media content item within the media player before, during, or after accessing or playing of the media content item; and only optionally buffers a portion of the media content item being accessed or played so that playback during a playback period is substantially continuous and uninterrupted during some predetermined percentage of time.

24. A media player as in claim 23, wherein the media player prefetches a predetermined or dynamically determined portion of a selected media content item and buffers it in a memory before initiating playing of the selected media content item.

25. A media player as in claim 1, wherein the buffering is determined based on media player to network source connection bandwidth and an available buffer storage.

26. A media player as in claim 1, wherein the additional playback means comprises a device having a video playback display screen.

27. A media player as in claim 15, wherein the network controller module (NCM) further comprises a network application logic that is operable to initiate and control a connection: (i) with server attached networked device having a server process executing thereon and the network application logic having a compatible network client application to communicate with the server process, (ii) with a directly attached networked device that is directly attached to the network without a server process executing thereupon and the network application logic not requiring a compatible network client application to communicate with the server process; and (iii) with either the server process attached networked device or the non-server directly attached network device.

28. A media player as in claim 27, wherein the network being selected from at least the set of networks consisting of: (i) a Network Attached Device (NAS) that may use one of a Network File Server (NFS) communication protocol, a Common Interface File Server (CIFS) protocol, or any other network communication protocol for communicating files, data, or commands over the network; and (ii) a directly attached NAD directly attached network device not having a server process executing thereupon.

28. A media player as in claim 27, wherein the networked directly attached device comprises a storage device having a storage device controller for controlling the operation of the storage device, and a network connection interface for communicating data and commands between the storage device controller and the network.

29. A media player as in claim 28, wherein the networked directly attached device network connection interface does not include a processor or microprocessor executing a server process, and the media player does not require execution of a client process to access or upload/download media content stored on the networked directly attached storage device.

30. A media player as in claim 29, wherein the networked directly attached device sends messages over the network identifying itself as a networked directly attached device so that the media player passively listening to communications present on the network can identify such networked directly attached devices and the directory search module can generate a list of the media content available from such networked directly attached devices and present them as items for selection on the media player display.

31. A media player as in claim 1, wherein the media player further includes a payment accounting means that stores media player device or user identification payment status for media content items that have been purchased where payment for purchase is required, so that the device may reaccess a previously paid for media content item without additional payment or with a discounted payment.

32. A media player as in claim 1, wherein the list comprises a data structure storing media content items and characteristics of the media content items, the characteristics of the media content items being selected from the set of characteristics consisting of a media content item name or other identifier, a media content item artist, a media content item play time, a media content item cost per play, a media content item payment status, a media content item category, a media content item copyright status or copyright owner, a media content item date, a media content item size, a media content item network device location, and any combination of these.

33. A media player as in claim 1, wherein the networked device storing a media content is identified by the media player as its own storage device, and the storage device may concurrently be accessed by a plurality of media players accessing either the same media content item or different media content items.

34. A media player as in claim 33, wherein the concurrent shared access of a particular networked storage device is facilitated by the networked storage device pre-fetching and communicating an amount of the content item so that each of the plurality of requesting media player will maintain continuous playback of their requested media content item with a predetermined high-probability, the media players buffering the prefetched portion of the media content item in a buffer but not prefetching the entire content of the media content item.

35. A media player as in claim 34, wherein the media player receives and buffers the entire media content item before beginning playback.

36. A media player as in claim 35, wherein the media player receives and buffers the entire media content item before beginning playback, but the media content item is deleted by the media player after playback of the particular media content item is completed.

37. A media player as in claim 1, wherein the content player module (22) further comprises a digital to analog converter circuit to convert a digital data stream to an analog signal.

38. A media player as in claim 1, wherein the content decoder module further comprises includes a decoder for decoding at least one of a multimedia signal, an audio signal, a video signal, a compressed audio signal, a compressed video signal, a television signal, a high-definition television signal, an MP3 signal, an MPEG signal, a compressed multimedia signal, a digital signal, an analog signal, a data signal, and/or any combination of these signals.

39. A media player as in claim 1, wherein the media player further comprises an encoder for encoding a media content obtained from any source including from the network or from a source local to the media player, and the encoder is adapted to encode a media content into at least one of a multimedia signal, an audio signal, a video signal, a compressed audio signal, a compressed video signal, a television signal, a high-definition television signal, an MP3 signal, an MPEG signal, a compressed multimedia signal, a digital signal, an analog signal, a data signal, and/or any combination of these signals.

40. A media player device as in claim 1, wherein the network and direct connections between the portable multimedia player and the networked storage device is selected from the set of connections consisting of an Ethernet connection, a USB connection, or an IEEE 1394 connection, and any combination of these.

41. A media player as in claim 1, wherein the network controller is adapted to communicate with a network over either a wired or a wireless communications link.

42. A media player as in claim 41, wherein the network controller is adapted to communicate with a network over a wireless communications link and the media player further includes it own internal power source so that it is usable as a portable wireless media player.

43. A media player as in claim 42, wherein media player has a size smaller than substantially 1 inch (25 mm)×3 inches (75 mm)×2 inches (50 mm).

44. A media player as in claim 1, wherein media player is incorporated into another electronic information appliance, the information appliance being selected from the set of information appliances consisting of a PDA, a digital camera, a cellular telephone, an automobile audio system, an automobile video system, a computer, a home entertainment system, a television, any audio or video device, and any combination of these.

45. A media player device as in claim 1, further comprising an audio output interface compatible with a headphone jack or plug, an ear-bud jack or plug, a speaker jack or plug, a Bluetooth wireless interface, a wired interface, or a wired interface.

46. A media player device as in claim 1, wherein the player module receives data for display on the display module that is decoded by the decoder module that decodes the multimedia contents in a supported format from the networked device.

47. A media player device as in claim 1, wherein logical, physical, and/or geographical separation of the player and the multimedia contents enables multiple media players to access all the contents stored in a single storage device substantially independently of others access.

48. A media player device as in claim 1, wherein the multimedia player has a direct connection to the networked storage once a direct connection is established with the external networked storage device away from a network.

49. A media player device as in claim 1, wherein when a plurality of media players are connected to a common external networked storage device via a network hub each of the plurality of media players recognizes the same external networked storage device as its own storage device.

50. A media player device as in claim 1, wherein the decoder module further includes: decoding means for decoding a television signal; and an interface for an television audio/video connection with an external television receiver/monitor (44, 45) so that the media player and the networked storage device in combination reproduce the television media contents on a television set, television receiver, or television display monitor.

51. A media player device as in claim 1, wherein display includes means for displaying a video signal and the decoder module includes means for decoding the video signal and displaying the video signal on the display.

52. A media player device as in claim 1, wherein multiple media players may be attached to the same networked storage device directly via a network hub, and the same single directly attached networked storage device provides substantially independent media content delivery services to each one of the attached media players with any and all of the media contents, and wherein each of the multiple media players recognize the attached networked storage device as its own storage device.

53. A media player device as in claim 1, wherein the player is an automobile based portable multimedia player.

54. A media player device as in claim 1, wherein the player is an aircraft based portable multimedia player.

55. A method for playing a media content item, the method comprising:
connecting to a network having at least one networked storage device, and identifying at least one media content data stored on the networked storage device;
sending a request to the networked storage device to access and play the identified media content data;
playing the identified requested media content data on a player from the storage device without storing the media content data on the player.

56. A method for playing a media content item as in claim 55, wherein the method further comprises: decoding the identified requested media content data and then playing the decoded media content data on the player.
